(19) United States
(12) Patent Application Publication
(10) Pub. No.: US 2009/0220406 A1
(43) Pub. Date: Sep. 3, 2009

(54) Selective Removal and Recovery of Acid Gases from Gasification Products

(75) Inventor: Mustafiz Rahman, Watertown, MA (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GREATPOINT ENERGY, INC., Chicago, IL (US)

(21) Appl. No.: 12/395,344

(22) Filed: Feb. 27, 2009

Related U.S. Application Data
(60) Provisional application No. 61/032,682, filed on Feb. 29, 2008.

(51) Int. Cl. C01B 31/20; C01B 3/38; B01D 50/00

(52) U.S. Cl. 423/437.1; 252/373; 422/169

(57) ABSTRACT

Processes and apparatuses are described for the selective removal and recovery of acid gases from a gas source comprising at least hydrogen sulfide and carbon dioxide. A step-wise approach is illustrated wherein hydrogen sulfide may be selectively removed from a gas source by treatment with methanol under conditions where substantially all the hydrogen sulfide may be removed. The partially purified gas source may then be provided with a second treatment with methanol under conditions which selectively remove carbon dioxide from the gas stream. Such methods are generally applicable to any gas source comprising at least hydrogen sulfide and carbon dioxide, for example, a gas source produced from the catalytic gasification of a carbonaceous material, the combustion of a carbonaceous material, or the oxy-blown gasification of a carbonaceous material.

### CROSS-REFERENCE TO RELATED APPLICATIONS

This application claims priority under 35 U.S.C. §119 from U.S. Provisional Application Ser. No. 61/032,682 (filed Feb. 29, 2008), the disclosure of which is incorporated by reference herein for all purposes as if fully set forth.

### FIELD OF THE INVENTION

The present invention relates to apparatuses and methods for the selective removal and recovery of hydrogen sulfide and carbon dioxide from a gaseous product. In particular, the gaseous product results from the catalytic gasification of a carbonaceous material.

### BACKGROUND OF THE INVENTION

In view of numerous factors such as higher energy prices and environmental concerns, the production of value-added gaseous products from lower-fuel-value carbonaceous feedstocks, such as biomass, coal and petroleum coke, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB1599932.

Carbonaceous fuel sources such as coal and petroleum coke are often contaminated by significant amounts of sulfur compounds. Upon their gasification, the sulfur is volatilzed as hydrogen sulfide, a noxious and corrosive gas which must be separated from the gasification product stream. Hydrogen sulfide can generally be removed by solvent extraction, with subsequent regeneration and recycle of the solvent. For example, see U.S. Pat. No. 2,813,126, U.S. Pat. No. 2,886,405, U.S. Pat. No. 3,435,590, U.S. Pat. No. 3,531,917, U.S. Pat. No. 3,594,985, U.S. Pat. No. 4,053,554, U.S. Pat. No. 4,091,073, U.S. Pat. No. 4,336,233, U.S. Pat. No. 4,330,305, U.S. Pat. No. 4,515,764, U.S. Pat. No. 5,093,094, U.S. Pat. No. 5,223,173, U.S. Pat. No. 5,277,884, U.S. Pat. No. 6,090,356, U.S. Pat. No. 6,506,349 and U.S. Pat. No. 6,797,253.

Unfortunately, available acid gas removal processes are not sufficiently selective and co-absorb significant CO₂. The most selective physical solvents, such as mixed dialkylethers of polyethylene glycol and N-methyl pyrrolidone, coabsorb over 15% of the CO₂ when solvent flow is set to remove essentially all of the H₂S. This results in a very dilute acid gas which cannot be processed in a conventional Claus plant. In commercial practice an expensive H₂S selective amine preconcentration is used to increase the Claus feed to 25% H₂S. Even at this concentration the purification is very expensive. Minimum CO₂ removal is required to obtain a concentrated H₂S Claus plant feed to minimize the capital and operating costs of the Claus plant. Therefore, there exists a need to develop new processes and apparatuses which can enable the selective removal of hydrogen sulfide with decreased carbon dioxide extraction from a gasification product stream.

### SUMMARY OF THE INVENTION

In a first aspect, the invention provides a process for removing hydrogen sulfide and carbon dioxide from a gas mixture, the process comprising the steps of: (A) providing a gas mixture comprising methane, carbon monoxide, hydrogen, hydrogen sulfide, and carbon dioxide; (B) contacting the gas mixture with a first absorber under a first set of operating conditions to produce a hydrogen sulfide-depleted gas stream and a hydrogen sulfide-laden absorber stream, the hydrogen sulfide-depleted gas stream comprising about 5 ppm or less of hydrogen sulfide; (C) recovering the hydrogen sulfide-laden absorber stream; (D) contacting the hydrogen sulfide-depleted gas stream with a second absorber under a second set of operating conditions to produce a carbon dioxide-depleted gas stream and a carbon dioxide-laden absorber stream, the carbon dioxide-depleted gas stream comprising about 50 ppm or less of carbon dioxide; and (E) recovering the carbon dioxide-laden absorber stream, wherein the first operating conditions comprise a first operating temperature and a first operating pressure, the second operating conditions comprise a second operating temperature and a second operating pressure, the first operating temperature is greater than the second operating temperature, and the first and second absorbers substantially comprise methanol.

In a second aspect, the invention provides an apparatus for the purification of a gaseous mixture comprising:
(a) a first unit comprising:
(a1) a first unit top portion,
(a2) a first unit bottom portion,
(a3) a first gaseous mixture feed line,
(a4) a first liquid feed line,
(a5) a first condenser in fluid communication with the first unit top portion, the first condenser comprising a first condenser overhead portion, a first condenser bottom portion, and a first gaseous product line in fluid communication with the first condenser overhead portion;
(a6) a first reboiler in fluid communication with the first unit bottom portion, and
(a7) a first bottoms line in fluid communication with the first unit bottom portion;

and (b) a second unit comprising:
(b1) a second unit top portion,
(b2) a second unit bottom portion,
(b3) a second gaseous mixture feed line in fluid communication with the first gaseous product line,
(b4) a second liquid feed line,
(b5) a second condenser in fluid communication with the second unit top portion, the second condenser comprising a second condenser overhead portion, a second condenser bottom portion, and a second gaseous product line in fluid communication with the second condenser overhead portion,
(b6) a second reboiler having a second reboiler top portion and a second reboiler bottom portion, in fluid communication with the second unit bottom portion, and
(b7) a second bottoms line in fluid communication with the second unit bottom portion or the second reboiler bottom portion.

In a third aspect, the invention provides a process for converting a carbonaceous composition into a plurality of gaseous products, the process comprising the steps of: (a) supplying a carbonaceous composition to a gasification reactor; (b) reacting the carbonaceous composition in the gasifying reactor in the presence of steam and a gasification catalyst under suitable temperature and pressure to form a plurality of gaseous products comprising methane, hydrogen, carbon monoxide, carbon dioxide and hydrogen sulfide, the gasification catalyst comprising an alkali metal; (c) removing a substantial portion of the hydrogen sulfide and carbon dioxide from the plurality of gaseous products according to the first aspect to produce a hydrogen sulfide and carbon dioxide-depleted product gas stream; and (d) at least partially separating the hydrogen sulfide and carbon dioxide-depleted product gas stream to produce a stream comprising a predominant amount of one of the remaining gaseous products.

### BRIEF DESCRIPTION OF THE DRAWINGS

FIG. 1 provides a schematic diagram for one example of a process for sequentially and selectively removing hydrogen sulfide and carbon dioxide from a gas source.

### DETAILED DESCRIPTION

The present invention relates to processes and apparatuses for the selective removal and recovery of acid gases from a gas source comprising at least hydrogen sulfide and carbon dioxide. Generally, a step-wise approach is provided wherein hydrogen sulfide may be removed from a gas source by treatment with methanol under conditions where substantially all the hydrogen sulfide may be removed. The partially purified gas source may then be provided with a second treatment with methanol under conditions which selectively remove carbon dioxide from the gas stream. Such methods are generally applicable to any gas source comprising at least hydrogen sulfide and carbon dioxide, for example, a gas source produced from the catalytic gasification of a carbonaceous material, the combustion of a carbonaceous material, or the oxy-blown gasification of a carbonaceous material.

The present invention can be practiced, for example, using any of the developments to catalytic gasification technology disclosed in commonly owned US2007/0000177A1, US2007/0083072A1 and US2007/0277437A1; and U.S. patent application Ser. No. 12/178,380 (filed 23 Jul. 2008), U.S. patent application Ser. No. 12/234,012 (filed 19 Sep. 2008) and U.S. patent application Ser. No. 12/234,018 (filed 19 Sep. 2008). All of the above are incorporated by reference herein for all purposes as if fully set forth.

Moreover, the present invention can be practiced in conjunction with the subject matter of the following U.S. patent applications, each of which was filed on Dec. 28, 2008: Ser. No. 12/342,554, entitled “CATALYTIC GASIFICATION PROCESS WITH RECOVERY OF ALKALI METAL FROM CHAR”; Ser. No. 12/342,565, entitled “PETROLEUM COKE COMPOSITIONS FOR CATALYTIC GASIFICATION”; Ser. No. 12/342,578, entitled “COAL COMPOSITIONS FOR CATALYTIC GASIFICATION”; Ser. No. 12/342,596, entitled “PROCESSES FOR MAKING SYNTHESIS GAS AND SYNGAS-DERIVED PRODUCTS”; Ser. No. 12/342,608, entitled “PETROLEUM COKE COMPOSITIONS FOR CATALYTIC GASIFICATION”; Ser. No. 12/342,628, entitled “PROCESSES FOR MAKING SYNGAS-DERIVED PRODUCTS”; Ser. No. 12/342,663, entitled “CARBONACEOUS FUELS AND PROCESSES FOR MAKING AND USING THEM”; Ser. No. 12/342,715, entitled “CATALYTIC GASIFICATION PROCESS WITH RECOVERY OF ALKALI METAL FROM CHAR”; Ser. No. 12/342,736, entitled “CATALYTIC GASIFICATION PROCESS WITH RECOVERY OF ALKALI METAL FROM CHAR”; Ser. No. 12/343,143, entitled “CATALYTIC GASIFICATION PROCESS WITH RECOVERY OF ALKALI METAL FROM CHAR”; Ser. No. 12/343,149, entitled “STEAM GENERATING SLURRY GASIFIER FOR THE CATALYTIC GASIFICATION OF A CARBONACEOUS FEEDSTOCK”; and Ser. No. 12/343,159, entitled “CONTINUOUS PROCESSES FOR CONVERTING CARBONACEOUS FEEDSTOCK INTO GASEOUS PRODUCTS”. All of the above are incorporated by reference herein for all purposes as if fully set forth.

Further, the present invention can be practiced in conjunction with the subject matter of the following U.S. patent applications, each of which was filed concurrently herewith: Ser. No. ______, entitled “PROCESSES FOR MAKING ABSORBENTS AND PROCESSES FOR REMOVING CONTAMINANTS FROM FLUIDS USING THEM” (attorney docket no. FN-0019 US NP1); Ser. No. ______, entitled “STEAM GENERATION PROCESSES UTILIZING BIOMASS FEEDSTOCKS” (attorney docket no. FN-0020 US NP1); Ser. No. ______, entitled “REDUCED CARBON FOOTPRINT STEAM GENERATION PROCESSES” (attorney docket no. FN-0021 US NP1); Ser. No. ______, entitled “PROCESS AND APPARATUS FOR THE SEPARATION OF METHANE FROM A GAS STREAM” (attorney docket no. FN-0022 US NP1); Ser. No. ______, entitled “COAL COMPOSITIONS FOR CATALYTIC GASIFICATION” (attorney docket no. FN-0024 US NP1); Ser. No. ______, entitled “COAL COMPOSITIONS FOR CATALYTIC GASIFICATION” (attorney docket no. FN-0025 US NP1); Ser. No. ______, entitled “CO-FEED OF BIOMASS AS SOURCE OF MAKEUP CATALYSTS FOR CATALYTIC COAL GASIFICATION” (attorney docket no. FN-0026 US NP1); Ser. No. ______, entitled “COMPACTOR-FEEDER” (attorney docket no. FN-0027 US NP1); Ser. No. ______, entitled “CARBONACEOUS FINES RECYCLE” (attorney docket no. FN-0028 US NP1); Ser. No. ______, entitled “BIOMASS CHAR COMPOSITIONS FOR CATALYTIC GASIFICATION” (attorney docket no. FN-0029 US NP1); Ser. No. ______, entitled “CATALYTIC GASIFICATION PARTICULATE COMPOSITIONS” (attorney docket no. FN-0030 US NP1); and Ser. No. ______, entitled “BIOMASS COMPOSITIONS FOR CATALYTIC GASIFICATION” (attorney docket no. FN-0031 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Although methods and materials similar or equivalent to those described herein can be used in the practice or testing of the present disclosure, suitable methods and materials are described herein.

Unless stated otherwise, all percentages, parts, ratios, etc., are by volume.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The materials, methods, and examples herein are illustrative only and, except as specifically stated, are not intended to be limiting.

### Gasification Methods

The extraction and recovery methods of the present invention are particularly useful in integrated gasification processes for converting carbonaceous feedstocks, such as petroleum coke, liquid petroleum residue and/or coal to combustible gases, such as methane.

The gasification reactors for such processes are typically operated at moderately high pressures and temperature, requiring introduction of a carbonaceous material (i.e., a feedstock) to the reaction zone of the gasification reactor while maintaining the required temperature, pressure, and flow rate of the feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

The catalyzed feedstock is provided to the catalytic gasifier from a feedstock preparation operation, and generally comprises a particulate composition of a crushed carbonaceous material and a gasification catalyst, as discussed below. In some instances, the catalyzed feedstock can be prepared at pressures conditions above the operating pressure of catalytic gasifier. Hence, the catalyzed feedstock can be directly passed into the catalytic gasifier without further pressurization.

Any of several catalytic gasifiers can be utilized. Suitable gasifiers include counter-current fixed bed, co-current fixed bed, fluidized bed, entrained flow, and moving bed reactors. A catalytic gasifier for gasifying liquid feeds, such as liquid petroleum residues, is disclosed in previously incorporated U.S. Pat. No. 6,955,695.

The pressure in the catalytic gasifier typically can be from about 10 to about 100 atm (from about 150 to about 1500 psig). The gasification reactor temperature can be maintained around at least about 450° C., or at least about 600° C., or at least about 900° C., or at least about 750° C., or about 600° C. to about 700° C.; and at pressures of at least about 50 psig, or at least about 200 psig, or at least about 400 psig, to about 1000 psig, or to about 700 psig, or to about 600 psig.

The gas utilized in the catalytic gasifier for pressurization and reactions of the particulate composition comprises steam, and optionally, oxygen or air, and are supplied, as necessary, to the reactor according to methods known to those skilled in the art.

For example, steam can be supplied to the catalytic gasifier from any of the steam boilers known to those skilled in the art can supply steam to the reactor. Such boilers can be powered, for example, through the use of any carbonaceous material such as powdered coal, biomass etc., and including but not limited to rejected carbonaceous materials from the particulate composition preparation operation (e.g., fines, supra). Steam can also be supplied from a second gasification reactor coupled to a combustion turbine where the exhaust from the reactor is thermally exchanged to a water source and produce steam. Alternatively, the steam may be provided to the gasification reactor as described in previously incorporated U.S. patent applications Ser. No. ______, entitled “STEAM GENERATION PROCESSES UTILIZING BIOMASS FEEDSTOCKS” (attorney docket no. FN-0020 US NP1), and Ser. No. ______, entitled “REDUCED CARBON FOOTPRINT STEAM GENERATION PROCESSES” (attorney docket no. FN-0021 US NP1).

Recycled steam from other process operations can also be used for supplementing steam to the catalytic gasifier. For example in the preparation of the catalyzed feedstock, when slurried particulate composition are dried with a fluid bed slurry drier, as discussed below, then the steam generated can be fed to the catalytic gasification reactor.

The small amount of required heat input for the catalytic gasifier can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the catalytic gasifier effluent followed by superheating in a recycle gas furnace.

A methane reformer can be included in the process to supplement the recycle CO and H₂ fed to the reactor to ensure that enough recycle gas is supplied to the reactor so that the net heat of reaction is as close to neutral as possible (only slightly exothermic or endothermic), in other words, that the reaction is run under thermally neutral conditions. In such instances, methane can be supplied for the reformer from the methane product, as described below.

Reaction of the catalyzed feedstock in the catalytic gasifier, under the described conditions, provides a crude product gas and a char from the catalytic gasification reactor.

The char includes, for example, mineral ash, unconverted carbonaceous material, gasification catalyst and other by-products. The char produced in the catalytic gasifier processes is typically removed from the catalytic gasifier for sampling, purging, and/or catalyst recovery in a continuous or batch-wise manner. Methods for removing char are well known to those skilled in the art. One such method taught by EP-A-0102828, for example, can be employed. The char can be periodically withdrawn from the catalytic gasification reactor through a lock hopper system, although other methods are known to those skilled in the art.

Often, the char from the catalytic gasifier is directed to a catalyst recovery and recycle process. Processes have been developed to recover alkali metal from the solid purge in order to reduce raw material costs and to minimize environmental impact of a catalytic gasification process. For example, the char can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512 and US2007/0277437A1, and previously incorporated U.S. patent application Ser. Nos. 12/342,554, 12/342,715, 12/342,736 and 12/343,143. Reference can be had to those documents for further process details.

Upon completion of catalyst recovery, both the char, substantially free of the gasification catalysts and the recovered catalyst (as a solution or solid) can be directed to the feedstock preparation operation comprising a catalyzed feedstock preparation process and a slurry feedstock preparation process.

Crude product gas effluent leaving the catalytic gasifier can pass through a portion of the reactor which serves as a disengagement zone where particles too heavy to be entrained by the gas leaving the reactor (i.e., fines) are returned to the fluidized bed. The disengagement zone can include one or more internal cyclone separators or similar devices for removing fines and particulates from the gas. The gas effluent passing through the disengagement zone and leaving the catalytic gasifier generally contains CH₄, CO₂, H₂ and CO, H₂S, NH₃, unreacted steam, entrained fines, and other contaminants such as COS.

The gas stream from which the fines have been removed can then be passed through a heat exchanger to cool the gas and the recovered heat can be used to preheat recycle gas and generate high pressure steam. Residual entrained fines can also be removed by any suitable means such as external cyclone separators, optionally followed by Venturi scrubbers. The recovered fines can be processed to recover alkali metal catalyst, or directly recycled back to feedstock preparation as described in previously incorporated U.S. patent application Ser. No. ______, entitled “CARBONACEOUS FINES RECYCLE” (attorney docket no. FN-0028 US NP1).

The gas stream from which the fines have been removed can be fed to COS hydrolysis reactors for COS removal (sour process) and further cooled in a heat exchanger to recover residual heat prior to entering water scrubbers for ammonia recovery, yielding a scrubbed gas comprising at least H₂S, CO₂, CO, H₂, and CH₄. Methods for COS hydrolysis are known to those skilled in the art, for example, see U.S. Pat. No. 4,100,256. The residual heat from the scrubbed gas can be used to generate low pressure steam.

Scrubber water and sour process condensate can be processed to strip and recover NH₃; such processes are well known to those skilled in the art. NH₃ can typically be recovered as an aqueous solution.

A subsequent acid gas removal process in accordance with the present invention, and as described in detail below, is used to remove H₂S and CO₂ from the scrubbed gas stream. Recovered H₂S can be sent for sulfur recovery processing, for example, by conversion to elemental sulfur by any method known to those skilled in the art, including the Claus process. Sulfur can be recovered as a molten liquid. Stripped water can be directed for recycled use in preparation of the catalyzed feedstock.

Advantageously, CO₂ generated in the process, whether in the steam generation or catalytic gasification or both, can be recovered for subsequent use or sequestration, enabling a greatly decreased carbon footprint (as compared to direct combustion of the feedstock) as a result.

The resulting cleaned gas stream exiting the gas purification operation contains mostly CH₄, H₂, and CO and, typically, small amounts of CO₂ and H₂O.

The cleaned gas stream can be further processed to separate and recover CH₄ by any suitable gas separation method known to those skilled in the art including, but not limited to, cryogenic distillation and the use of molecular sieves or ceramic membranes. One method for separating and recovering methane from the cleaned gas stream are described in previously incorporated U.S. patent application Ser. No. ______, entitled “PROCESS AND APPARATUS FOR THE SEPARATION OF METHANE FROM A GAS STREAM” (attorney docket no. FN-0022 US NP1).

Typically, two gas streams can be produced by the recovery processing, a methane product stream and a syngas stream (H₂ and CO). The syngas stream can be compressed and recycled. One option can be to recycle the syngas steam directly to the catalytic gasifier. If necessary, a portion of the methane product can be directed to a reformer to provide a ratio of about 3:1 of H₂ to CO in the feed to the catalytic gasification reactor. A portion of the methane product can also be used as plant fuel for a gas turbine.

### Carbonaceous Composition

The term “carbonaceous composition” or “carbonaceous material” as used herein includes a carbon source, typically coal, petroleum coke, asphaltene and/or liquid petroleum residue, but may broadly include any source of carbon suitable for gasification, including biomass.

The term “petroleum coke” as used herein includes both (i) the solid thermal decomposition product of high-boiling hydrocarbon fractions obtained in petroleum processing (heavy residues—“resid petcoke”) and (ii) the solid thermal decomposition product of processing tar sands (bituminous sands or oil sands—“tar sands petcoke”). Such carbonization products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % of less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as compounds of silicon and/or aluminum.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

The term “asphaltene” as used herein is an aromatic carbonaceous solid at room temperature, and can be derived, from example, from the processing of crude oil and crude oil tar sands.

The term “liquid petroleum residue” as used herein includes both (i) the liquid thermal decomposition product of high-boiling hydrocarbon fractions obtained in petroleum processing (heavy residues—“resid liquid petroleum residue”) and (ii) the liquid thermal decomposition product of processing tar sands (bituminous sands or oil sands—“tar sands liquid petroleum residue”). The liquid petroleum residue is substantially non-solid; for example, it can take the form of a thick fluid or a sludge.

Resid liquid petroleum residue can also be derived from a crude oil, for example, by processes used for upgrading heavy-gravity crude oil distillation residue. Such liquid petroleum residue contains ash as a minor component, typically about 1.0 wt % or less, and more typically about 0.5 wt % of less, based on the weight of the residue. Typically, the ash in such lower-ash residues predominantly comprises metals such as nickel and vanadium.

Tar sands liquid petroleum residue can be derived from an oil sand, for example, by processes used for upgrading oil sand. Tar sands liquid petroleum residue contains ash as a minor component, typically in the range of about 2 wt % to about 12 wt %, and more typically in the range of about 4 wt % to about 12 wt %, based on the overall weight of the residue. Typically, the ash in such higher-ash residues predominantly comprises materials such as compounds of silicon and/or aluminum.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on total coal weight. Examples of useful coals include, but are not limited to, Illinois #6, Pittsburgh #8, Beulah (N. Dak.), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art (see, for example, Coal Data: A Reference, Energy Information Administration, Office of Coal, Nuclear, Electric and Alternate Fuels, U.S. Department of Energy, DOE/EIA-0064(93), February 1995).

The term “ash” as used herein includes inorganic compounds that occur within the carbon source. The ash typically includes compounds of silicon, aluminum, calcium, iron, vanadium, sulfur, and the like. Such compounds include inorganic oxides, such as silica, alumina, ferric oxide, etc., but may also include a variety of minerals containing one or more of silicon, aluminum, calcium, iron, and vanadium. The term “ash” may be used to refer to such compounds present in the carbon source prior to gasification, and may also be used to refer to such compounds present in the char after gasification.

### Catalyst-Loaded Carbonaceous Feedstock

The carbonaceous composition is generally loaded with an amount of an alkali metal. Typically, the quantity of the alkali metal in the composition is sufficient to provide a ratio of alkali metal atoms to carbon atoms ranging from about 0.01, or from about 0.02, or from about 0.03, or from about 0.04, to about 0.06, or to about 0.07, or to about 0.08. Further, the alkali metal is typically loaded onto a carbon source to achieve an alkali metal content of from about 3 to about 10 times more than the combined ash content of the carbonaceous material (e.g., coal and/or petroleum coke), on a mass basis.

Alkali metal compounds suitable for use as a gasification catalyst include compounds selected from the group consisting of alkali metal carbonates, bicarbonates, formates, oxalates, amides, hydroxides, acetates, halides, nitrates, sulfides, and polysulfides. For example, the catalyst can comprise one or more of Na₂CO₃, K₂CO₃, Rb₂CO₃, Li₂CO₃, Cs₂CO₃, NaOH, KOH, RbOH, or CsOH, and particularly, potassium carbonate and/or potassium hydroxide.

Any methods known to those skilled in the art can be used to associate one or more gasification catalysts with the carbonaceous composition. Such methods include, but are not limited to, admixing with a solid catalyst source and impregnating the catalyst onto the carbonaceous solid. Several impregnation methods known to those skilled in the art can be employed to incorporate the gasification catalysts. These methods include, but are not limited to, incipient wetness impregnation, evaporative impregnation, vacuum impregnation, dip impregnation, and combinations of these methods. Gasification catalysts can be impregnated into the carbonaceous solids by slurrying with a solution (e.g., aqueous) of the catalyst.

That portion of the carbonaceous feedstock of a particle size suitable for use in the gasifying reactor can then be further processed, for example, to impregnate one or more catalysts and/or cocatalysts by methods known in the art, for example, as disclosed in U.S. Pat. No. 4,069,304, U.S. Pat. No. 4,092,125, U.S. Pat. No. 4,468,231, U.S. Pat. No. 4,551,155 and U.S. Pat. No. 5,435,940; and U.S. patent applications Ser. Nos. 12/234,012, 12/234,018, 12/342,565, 12/342,578, 12/342,608 and 12/343,159.

One particular method suitable for combining the coal particulate with a gasification catalyst to provide a catalyzed carbonaceous feedstock where the catalyst has been associated with the coal particulate via ion exchange is described in previously incorporated U.S. patent application Ser. No. 12/178,380. The catalyst loading by ion exchange mechanism is maximized (based on adsorption isotherms specifically developed for the coal), and the additional catalyst retained on wet including those inside the pores is controlled so that the total catalyst target value is obtained in a controlled manner. Such loading provides a catalyzed coal particulate as a wet cake. The catalyst loaded and dewatered wet coal cake typically contains, for example, about 50% moisture. The total amount of catalyst loaded is controlled by controlling the concentration of catalyst components in the solution, as well as the contact time, temperature and method, as can be readily determined by those of ordinary skill in the relevant art based on the characteristics of the starting coal.

The catalyzed feedstock can be stored for future use or transferred to a feed operation for introduction into the gasification reactor. The catalyzed feedstock can be conveyed to storage or feed operations according to any methods known to those skilled in the art, for example, a screw conveyer or pneumatic transport.

### Acid Gas Removal and Recovery

As indicated previously, a subsequent acid gas removal process can be used to remove H₂S and CO₂ from the scrubbed gas stream by a physical absorption method involving solvent treatment of the gas to give a cleaned gas stream. The resulting cleaned gas stream contains mostly CH₄, H₂, and CO and, typically, small amounts of CO₂.

The scrubbed gas produced from the catalytic gasification of a carbonaceous material may be processed to selectively remove acid gases in a stepwise process. Acid gases are gases which are, themselves acids, for example, hydrogen sulfide; or form an acid upon addition to water, for example, carbon dioxide. While the following processes are exemplified, in particular, for the removal of acid gases from a scrubbed gas from a catalytic gasification process, it will be understood by one skilled in the art that the processes of the present invention may be utilized on any gaseous source comprising at least carbon dioxide and hydrogen sulfide. For example, the following processes may be used for the purification of a raw gaseous source comprising carbon monoxide, hydrogen, hydrogen sulfide, and carbon dioxide, produced from combustion or oxy-blown gasification of a carbonaceous material.

The terms “top portion” or “overhead portion” and “bottom portion” as used herein, mean the top or bottom ⅓ of the referenced structure, respectively. As is familiar to those skilled in the art, the portion of the first and second units, and the first and second liquid-gas separation units, as discussed below, above the point where a gaseous mixture feed line enters the unit is a rectifying section and the portion of the unit below a gaseous mixture feed line is a stripping section. In general, and without being limited by any one theory of operation, the stripping section strips out the light ends to make the bottom product on specification and the rectifying section rectifies the overhead product to make the overhead product on specification. In the first and second units the rectifying sections help minimize the loss of H₂S and CO₂ respectively. In the first and second gas-liquid separation units the rectifying sections help minimize the loss of absorber (e.g., methanol).

1. H₂S Removal and Recovery

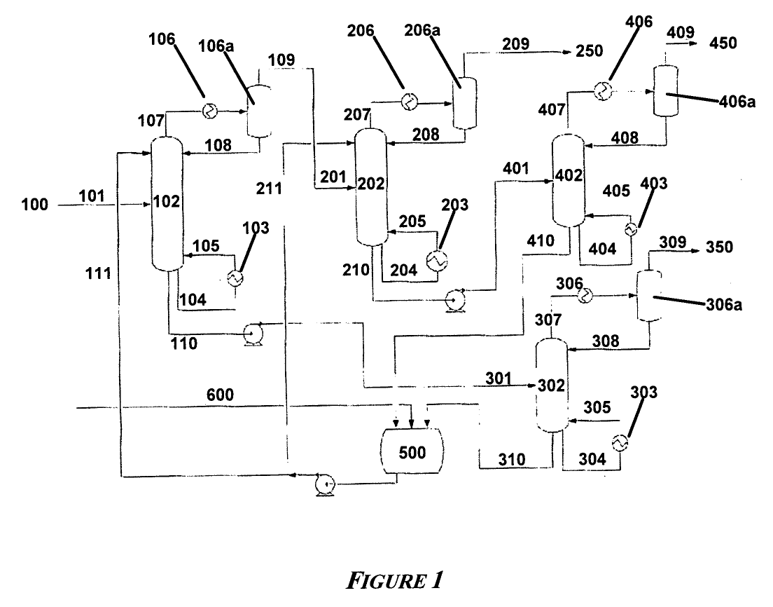

To remove and recover hydrogen sulfide from a gas mixture (100, FIG. 1), the gas mixture comprising, for example, methane, carbon monoxide, hydrogen, hydrogen sulfide, and carbon dioxide can be contacted with a first absorber under a first set of operating conditions to produce a first overhead stream substantially depleted of hydrogen sulfide and a hydrogen sulfide-laden absorber stream as a first bottoms stream. Absorbers (i.e., first absorber, second absorber), as used herein, mean chemical compounds known to those skilled in the art which are capable of removing gaseous contaminants from a gas source; for example, absorbers include, but are not limited to, methanol (Recticol®; Lurgi AG, Frankfurt am Main, Germany), ethanol, Selexol® (UOP LLC, Des Plaines, Ill. USA), monoethanolamine (MEA), diethanolamine (DEA), methyldiethanolamine (MDEA), diisopropylamine (DIPA), and diglycolamine (DGA). In particular embodiments, first absorber consists essentially of methanol.

The contacting may take place in a first unit (102) comprising a first unit top portion; a first unit bottom portion; a first gaseous mixture feed line (101); a first liquid feed line (111); a first condenser (106) in fluid communication with the first unit top portion, the first condenser comprising a first condenser overhead portion, a first condenser bottom portion, and a first gaseous product line (109) in fluid communication with the first condenser overhead portion; a first reboiler (103) in fluid communication with the first unit bottom portion, and a first bottoms line (110) in fluid communication with the first unit bottom portion. Ultimately, a hydrogen sulfide-depleted gas stream is withdrawn via the first gaseous product line (109) and the hydrogen sulfide-laden absorber stream is withdrawn as a first bottoms stream via the first bottoms line (110).

The first unit (102) may comprise any vessel capable of maintaining the first absorber and the gas mixture at the proper temperature and pressure. For example, the first unit (102) may comprise a column, drum, or tank. Preferably, the first unit (102) comprises a first column. The first liquid feed line (111) generally feeds the first absorber to the first unit (102) at a position within the first unit top portion. The first gaseous mixture feed line (101) may feed the gas mixture (100) to be processed (e.g., the scrubbed gas, supra) at a point between the top and bottom portions of the first unit. For example, a catalytic gasification reactor may be in fluid communication with the first gaseous mixture feed line (101) and may provide the gas mixture (100) to the first unit (102).

The first unit operates under a set of first operating conditions comprising a first operating temperature and a first operating pressure. Generally, the first operating pressure is higher within the first bottom portion with respect to the first top portion For example, the first operating pressure may range from about 400 psia at within the first top portion to about 500 psia within the first bottom portion. In particular, the first operating pressure may range from about 450 psia within the top portion to about 460 psia within the bottom portion.

Further, the first operating temperature is typically higher within the first unit bottom portion with respect to the first unit top portion. For example, the first operating temperature within the first unit top portion may range from about −10° F. (−24° C.) to about −5° F. (−20° C.) and the first operating temperature within the first unit bottom portion may range from about 250° F. (120° C.) to about 350° F. (176° C.).

The first condenser (106) typically comprises a first condenser overhead portion, a first condenser bottom portion, a first condenser inlet line in fluid communication from the first unit top portion, a first condenser recycle line in fluid communication back to the first unit from the first condenser bottom portion, and a first gaseous product line in fluid communication with the first condenser overhead portion. In general, the first condenser comprises a heat exchanger which reduces the temperature of the first overhead stream. The first condenser may further comprise additional elements to enhance condensation and/or liquid-gas separation, for example, a flash drum (106a). Thereby, the first overhead stream passes to first condenser (106) via the first condenser inlet line (107) and may be at least partially condensed to yield a hydrogen sulfide-depleted gas stream and a first condenser recycle stream. The first condenser recycle stream may be returned to the first unit (102) via the first condenser recycle line (108), and the hydrogen sulfide-depleted gas stream may be withdrawn via the first gaseous product line (109).

The first reboiler (103) may comprise any reboiler known to those skilled in the art and is in fluid communication with the first unit bottom portion. Reboilers (i.e., first reboiler, second reboiler, etc.), as used herein, are heat exchangers used to provide heat to the bottom of a unit, for example a column or drum, which boil the liquid withdrawn from the bottom of the unit to generate vapors which are returned to the column and include, for example, kettle reboilers, thermosyphon reboilers, direct hot fluid injection, and forced circulation reboilers, The first reboiler (103) continuously withdraws a first reboiler stream, via a first reboiler withdrawal line (104), from the first unit (102) that is reboiled and recycled back to the first unit (102) via a first reboiler recycle line (105), as a first reboiled stream. Both the first reboiler stream and first reboiled stream are withdrawn and returned, respectively, at points within the first unit bottom portion. The first reboiler (103) may operate at a temperature ranging from about 300° F. (148° C.) to about 400° F. (205° C.), and preferably, from about 350° F. (148° C.) to about 375° F. (191° C.); more preferably about 360° F. to about 370° F. In general, the first reboiler is operated at a temperature which yields a first reboiled stream wherein about 15-25 wt %, and preferably about 20 wt % of the methanol in the first reboiler stream is converted to gaseous methanol in the first reboiled stream.

The hydrogen sulfide-depleted gas stream produced by the preceding methods generally comprises about 5 ppm or less, or about 2 ppm or less, or about 1 ppm or less, of hydrogen sulfide. In particular, the hydrogen sulfide-depleted gas stream may comprise from about 0.1 ppm to about 5 ppm, or from about 0.1 to about 2 ppm, or from about 0.1 to about 1 ppm, of hydrogen sulfide. The hydrogen sulfide-laden absorber stream comprises methanol and substantially all the hydrogen sulfide from the gas mixture. The hydrogen sulfide-depleted gas stream may be directed to a second unit for the removal and recovery of carbon dioxide (infra).

The hydrogen sulfide-laden absorber stream may be recovered via the first bottoms line (110) as a first bottoms stream and directed via recovery line (301) to a first liquid-gas separation unit (302) where the first bottoms stream may be stripped to substantially remove all of the hydrogen sulfide from the first bottoms stream and to produce a first recovery stream comprising the stripped hydrogen sulfide, and a second recovery stream comprising the first absorber.

The separation process may be performed in a first liquid-gas separation unit (302) in fluid communication with the first bottoms line of the first unit (102). The first liquid-gas separation unit (302) comprises, for example, a first liquid-gas separation unit top portion, a first liquid-gas separation unit bottom portion, and a first liquid recycle line (310) in fluid communication with the first liquid-gas separation unit bottom portion. The first liquid-gas separation unit may further comprise a third condenser (306) in fluid communication with the first liquid-gas separation unit top portion where the third condenser (306) comprises a third condenser overhead portion, a third condenser bottom portion, a first gas exhaust line (309) in fluid communication with the third condenser overhead portion, a third condenser inlet line (307) in fluid communication from the first liquid-gas separation unit top portion and a third condenser recycle line (308) in fluid communication back to the first liquid-gas separation unit. Generally, both the third condenser inlet line (307) and the third condenser recycle line (308) are in fluid communication with the third condenser bottom portion.

In other embodiments, the first liquid-gas separation unit (302) may further comprise a third reboiler (303) in fluid communication with the first liquid-gas separation unit bottom portion. The third reboiler (303) generally comprises both a third reboiler withdrawal line (304) and a third reboiler recycle line (305). The third reboiler (303) may comprise any reboiler known to those skilled in the art.

The first liquid-gas separation unit (302) may comprise any vessel capable of maintaining the proper temperature and pressure; for example, first liquid-gas separation unit may comprise a column, drum, or tank. Preferably, first liquid-gas separation unit comprises a column.

The first liquid-gas separation unit (302) operates by introducing the hydrogen sulfide-laden absorber stream into the separation unit, wherein a first recovery stream is produced comprising hydrogen sulfide and a second recovery stream is produced comprising the first absorber. The third reboiler (303) operates by continuously withdrawing a third reboiler stream from the first liquid-gas separation unit via the third reboiler withdrawal line (304) that is reboiled then recycled back to the first liquid-gas separation unit as a third reboiled stream via the third reboiler recycle line (305). Both the third reboiler stream and third reboiled stream are withdrawn and returned, respective at points within the first liquid-gas separation unit bottom portion.

The first recovery stream, comprising hydrogen sulfide, may pass to the third condenser (306), via the third condenser inlet line (307), where any condensables (e.g., entrained first absorber) can be removed and returned to the first liquid-gas separation unit via the third condenser recycle line (308). The third condenser may further comprise additional elements to enhance condensation and/or liquid-gas separation, for example, a flash drum (306a). The first recovery stream (350) can be recovered via the first gas exhaust line (309) in fluid communication with the third condenser overhead portion. The first gas exhaust line (309) may be in fluid communication with a sulfur recovery unit where the first recovery stream (350) may be treated, for example via the Claus process, to recover elemental sulfur.

The second recovery stream may be recovered via the first liquid recycle line (310) in fluid communication with the first liquid-gas separation unit bottom portion. The recovered second recovery stream may be recycled for use as the first and/or second absorber. That is, in various embodiments, the first liquid recycle line (310) may be in fluid communication with the first liquid feed line (111) and/or the second liquid feed line (211, infra). Alternatively, the second recovery stream may be directed, via the first liquid recycle line (310), to a holding tank (500) for providing methanol to the first liquid feed line (111) and/or the second liquid feed line (211, infra). Any required make-up methanol for use as the first and/or second absorber may be supplied to the holding tank via a methanol make-up line (600) in fluid communication with the holding tank.

2. CO₂ Removal and Recovery

Carbon dioxide may be removed and recovered from the hydrogen sulfide-depleted gas stream by contacting the gas stream with a second absorber under a second set of operating conditions to produce a second overhead stream substantially depleted of carbon dioxide and a carbon dioxide-laden absorber stream as a second bottoms stream, wherein second absorber consists essentially of methanol.

The contacting may take place in a second unit (202) comprising a second unit top portion; a second unit bottom portion; a second gaseous mixture feed line (201) in fluid communication with the first gaseous product line (109); a second liquid feed line (211); a second condenser (206) in fluid communication with the second unit top portion, the second condenser (206) comprising a second condenser overhead portion, a second condenser bottom portion, and a second gaseous product line (209) in fluid communication with the second condenser overhead portion; a second reboiler (203), having a second reboiler top portion and a second reboiler bottom portion, in fluid communication with the second unit bottom portion, and a second bottoms line (210) in fluid communication with the second unit bottom portion or the second reboiler bottom portion. Ultimately, a carbon dioxide-depleted gas stream (250) is withdrawn via the second gaseous product line (209) and the carbon dioxide-laden absorber stream is withdrawn as a second bottoms stream via the second bottoms line (210).

The second unit (202) may comprise any vessel capable of maintaining the second absorber and the gas mixture at the proper temperature and pressure. For example, the second unit may comprise a column, drum, or tank. Preferably, the second unit comprises a second column. The second liquid feed line generally feeds the second absorber to the second unit at a position within the second unit top portion. The second gaseous mixture feed line (201) may feed the gas mixture to be processed (e.g., the hydrogen sulfide-depleted gas stream, supra) at a point between the top and bottom portions of the second unit (202).

The second unit (202) operates under a set of second operating conditions comprising a second operating temperature and a second operating pressure, however, the second operating temperature and second operating pressure are each lower than the first operating temperature and the first operating pressure, respectively. Generally, the second operating pressure is higher within the second unit bottom portion with respect to the second unit top portion For example, the second operating pressure may range from about 420 psia at within the second unit top portion to about 455 psia within the second unit bottom portion. In particular, the second operating pressure may range from about 435 psia within the second unit top portion to about 455 psia within the second unit bottom portion.

Further, the second operating temperature is typically higher within the second unit bottom portion with respect to the second unit top portion. For example, the second operating temperature within the second unit top portion may range from about −45° F. (−43° C.) to about −30° F. (−34° C.) and the second operating temperature within the second unit bottom portion may range from about −40° F. (−40° C.) to about −35° F. (−37° C.).

The second condenser (206) comprises a second condenser overhead portion, a second condenser bottom portion, a second condenser inlet line (207) in fluid communication from the second unit top portion, a second condenser recycle line (208) in fluid communication back to the second unit from the second condenser bottom portion, and a second gaseous product line (209) in fluid communication with the second condenser overhead portion. In general, the second condenser (206) comprises a heat exchanger which reduces the temperature of the second overhead stream. The second condenser may further comprise additional elements to enhance condensation and/or liquid-gas separation, for example, a flash drum (206a). Thereby, the second overhead stream passes to second condenser (206) via the second condenser inlet line (207) and may be at least partially condensed to yield a carbon dioxide-depleted gas stream (250) and a second condenser recycle stream. The second condenser recycle stream may be recycled back to the second unit (202) via the second condenser recycle line (208), and the carbon dioxide-depleted gas stream (250) may be withdrawn via the second gaseous product line (209).

The second reboiler (203), having a second reboiler top portion and a second reboiler bottom portion, may comprise any reboiler known to those skilled in the art and is in fluid communication with the second unit bottom portion. In certain embodiments, the second bottoms line (210) is in fluid communication with the second reboiler bottom portion. The second reboiler (203) continuously withdraws a second reboiler stream, via a second reboiler withdrawal line (204), from the second unit (206) that is reboiled and recycled back to the second unit, via a second reboiler recycle line (205), as a second reboiled stream. Both the second reboiler stream and second reboiled stream are withdrawn and returned, respectively, at points within the second unit bottom portion. The second reboiler (203) may operate at a temperature ranging from about 200° F. (93° C.) to about 250° F. (122° C.), and preferably, from about 210° F. (98° C.) to about 220° F. (105° C.); more preferably about 215° F. (101° C.) to about 225° F. (108° C.). In general, the second reboiler is operated at a temperature which yields a second reboiled stream wherein the second reboiled stream comprises less than 10 wt % of the second absorber in the second reboiled stream (e.g., methanol) in a gaseous form.

The carbon dioxide-depleted gas stream (250) produced by the preceding methods generally comprises about 50 ppm or less of carbon dioxide. In particular, the carbon dioxide-depleted gas stream may comprise from about 25 ppm to about 50 ppm carbon dioxide. The carbon dioxide-depleted gas stream may be directed to a further unit for the removal and recovery of additional gaseous component (e.g., methane, carbon monoxide and/or hydrogen, infra).

The carbon dioxide-laden absorber stream comprises methanol and substantially all the carbon dioxide from the hydrogen sulfide-depleted gas stream. According to the present processes, the carbon dioxide-laden absorber stream may be recovered at a pressure ranging from about 350 psia to about 450 psia. The carbon dioxide-laden absorber stream may be recovered via the second bottoms line (210) as a second bottoms stream and directed via recovery line (401) to a second liquid-gas separation unit (402) for separation of the absorbed carbon dioxide and the second absorber. The second bottoms stream may be stripped to substantially remove all of the carbon dioxide from the second bottoms stream and to produce a third recovery stream comprising the stripped carbon dioxide, and a fourth recovery stream comprising the second absorber.

The separation process may be preformed in a second liquid-gas separation unit (402) in fluid communication with the second bottoms line (210). As noted previously, the second bottoms line may originate from either the second unit bottom portion or the second reboiler bottom portion. The second liquid-gas separation unit (402) comprises, for example, a second liquid-gas separation unit top portion, a second liquid-gas separation unit bottom portion, and a second liquid recycle line (410) in fluid communication with the second liquid-gas separation unit bottom portion. The second liquid-gas separation unit (402) may further comprise a fourth condenser (406) in fluid communication with the second liquid-gas separation unit top portion where the fourth condenser (406) comprises a fourth condenser overhead portion, a fourth condenser bottom portion, a second gas exhaust line (409) in fluid communication with the fourth condenser overhead portion, a fourth condenser inlet line (407) in fluid communication from the second liquid-gas separation unit top portion and a fourth condenser recycle line (408) in fluid communication back to the second liquid-gas separation unit. The fourth condenser (406) may further comprise additional elements to enhance condensation and/or liquid-gas separation, for example, a flash drum (406a). Generally, both the fourth condenser inlet line (407) and the fourth condenser recycle line (408) are in fluid communication with the fourth condenser bottom portion.

In other embodiments, the second liquid-gas separation unit (402) may further comprise a fourth reboiler (403) in fluid communication with the second liquid-gas separation unit bottom portion. The fourth reboiler (403) generally comprises both a fourth reboiler withdrawal line (404) and a fourth reboiler recycle line (405). The fourth reboiler (403) may comprise any reboiler known to those skilled in the art.

The second liquid-gas separation unit (402) may comprise any vessel capable of maintaining the proper temperature and pressure; for example, second liquid-gas separation unit may comprise a column, drum, or tank. Preferably, second liquid-gas separation unit comprises a column.

The second liquid-gas separation unit (402) operates by introducing the carbon dioxide-laden absorber stream into the separation unit, wherein a third recovery stream is produced comprising carbon dioxide and a fourth recovery stream is produced comprising the second absorber. The fourth reboiler (403) operates continuously to withdraw a fourth reboiler stream from the second liquid-gas separation unit (402) via the fourth reboiler withdrawal line (404) that is reboiled then recycled back to the second liquid-gas separation unit as a fourth reboiled stream via the fourth reboiler recycle line (405). Both the fourth reboiler stream and fourth reboiled stream are withdrawn and returned, respective at points within the second liquid-gas separation unit bottom portion.

The third recovery stream comprising carbon dioxide may pass to the fourth condenser (406), via the fourth condenser inlet line (407), where any condensables (e.g., entrained second absorber) can be removed and returned to the second liquid-gas separation unit via the fourth condenser recycle line (408). The third recovery stream (450) can be recovered via the second gas exhaust line (409) in fluid communication with the fourth condenser overhead portion. According to the present processes, the third recovery stream (450), comprising carbon dioxide, may be recovered at a pressure up to 450 psia. Generally, the third recovery stream (450), comprising carbon dioxide, can be recovered at a pressure ranging from about 350 psia to about 450 psia. The second gas exhaust line (409) may be in fluid communication with, for example, a pressurization pump for increasing the gas pressure for sequestration.

The fourth recovery stream may be recovered via the second liquid recycle line (410) in fluid communication with the second liquid-gas separation unit bottom portion. The recovered fourth recovery stream may be recycled for use as the first and/or second absorber. That is, in various embodiments, the second liquid recycle line (410) may be in fluid communication with the first liquid feed line (111) and/or the second liquid feed line (211). Alternatively, the fourth recovery stream may be directed, via the second liquid recycle line (410), to a holding tank (500) for providing methanol to the first liquid feed line (111) and/or the second liquid feed line (211, infra).

The carbon dioxide-depleted gas stream (250) (i.e., a cleaned gas stream) can be further processed to separate remaining gaseous components. For example, from a gas source produced from the catalytic gasification of a carbonaceous material, methane may be recovered from the carbon dioxide-depleted gas stream (250) by any suitable gas separation method known to those skilled in the art including, but not limited to, cryogenic distillation and the use of molecular sieves or ceramic membranes.

One method for recovering CH₄ from the cleaned gas stream involves the combined use of molecular sieve absorbers to remove residual H₂O and CO₂ and cryogenic distillation to fractionate and recover CH₄. Typically, two gas streams can be produced by the gas separation process, a methane product stream and a syngas stream (H₂ and CO). The syngas stream can be compressed and recycled to the gasification reactor. If necessary, a portion of the methane product can be directed to a reformer, as discussed previously and/or a portion of the methane product can be used as plant fuel.

### EXAMPLES

### Example 1

### Particulate Composition Gasification and Acid Gas Removal

A carbonaceous composition comprising wet ground Powder River Basin coal can be slurried with a soaking solution containing potassium hydroxide and potassium carbonate in water with a slurry density of approximately 20 wt % for about 2 hours at 150° C. (300° F.), dewatered and provided to a fluidized bed gasification reactor, under positive nitrogen pressure, fed by an enriched oxygen source and a high-pressure steam source. Typical conditions for the catalytic gasifier would be: total pressure, 500 psi and temperature, 1200° F. (about 648° C.). The effluent of the reactor should be found to contain methane, CO₂, H₂, CO, water, H₂S, ammonia, and nitrogen. The effluent would be scrubbed to remove entrained fines and ammonia and a dehydration system and passed to an acid gas removal process.

The effluent can be provided to an H₂S extraction column having a reboiler and containing methanol at a temperature of −7° F. (−21° C.) at the top of the extraction column and 300° F. (149° C.) at the bottom of the column, and a pressure of 454 psia at the top of the extraction column and 460 psia at the bottom of the extraction column; with the reboiler operating at a temperature of 364° F. (184° C.). The H₂S extraction column should produce an overhead gas substantially depleted of H₂S and an H₂S-enriched methanol stream. The overhead gas would be passed through a condenser and flash drum to condense entrained methanol, which would then be returned to the extraction column. The resulting H₂S-depleted gas stream should contain less than about 1 ppm H₂S.

The H₂S-depleted gas stream would be provided to a CO₂ absorption column having a reboiler and containing methanol at a temperature of −38° F. (−39° C.) at the top of the extraction column and 200° F. (93° C.) at the bottom of the column, and a pressure of 438 psia at the top of the extraction column and 454 psia at the bottom of the extraction column; with the reboiler operating at a temperature of 220° F. (104° C.). The CO₂ extraction column should produce an overhead gas substantially depleted of CO₂ and a CO₂-enriched methanol stream. The overhead gas would be passed through a condenser and flash drum to condense entrained methanol, which would then be returned to the extraction column. The resulting CO₂-depleted gas stream would be collected from the overhead of the condenser and should contain methane, carbon monoxide, hydrogen, and less than about 50 ppm CO₂.

We claim:

1. A process for removing hydrogen sulfide and carbon dioxide from a gas mixture, the process comprising the steps of:
(A) providing a gas mixture comprising methane, carbon monoxide, hydrogen, hydrogen sulfide, and carbon dioxide;
(B) contacting the gas mixture with a first absorber under a first set of operating conditions to produce a hydrogen sulfide-depleted gas stream and a hydrogen sulfide-laden absorber stream, the hydrogen sulfide-depleted gas stream comprising about 5 ppm or less hydrogen sulfide;
(C) recovering the hydrogen sulfide-laden absorber stream;
(D) contacting the hydrogen sulfide-depleted gas stream with a second absorber under a second set of operating conditions to produce a carbon dioxide-depleted gas stream and a carbon dioxide-laden absorber stream, the carbon dioxide-depleted gas stream comprising about 50 ppm or less of carbon dioxide; and
(E) recovering the carbon dioxide-laden absorber stream;
wherein:
the first operating conditions comprise a first operating temperature and a first operating pressure,
the second operating conditions comprise a second operating temperature and a second operating pressure,
the first operating temperature is greater than the second operating temperature, and
the first and second absorbers substantially comprise methanol.

2. The process of claim 1, further comprising the step of recovering carbon dioxide from the carbon dioxide-laden at a pressure ranging from about 350 psia to about 450 psia.

3. The process of claim 1, wherein step (B) comprises the steps of:
(B1) feeding the gas mixture into a first unit;
(B2) feeding the first absorber into the first unit;
(B3) contacting the gas mixture and the first absorber in the first unit under conditions to produce a first overhead gas stream, and a first bottoms stream that is the hydrogen sulfide-laden absorber stream;
(B4) partially condensing the first overhead gas stream to produce a first condenser recycle stream that is recycled back to the first unit, and the hydrogen sulfide-depleted gas stream that is withdrawn; and
(B5) withdrawing a first reboiler stream from the first unit, that is reboiled then recycled back to the first unit.

4. The process of claim 1, wherein step (D) comprises the steps of:
(D1) feeding the hydrogen sulfide-depleted gas stream into a second unit;
(D2) feeding the second absorber into the second unit;
(D3) contacting the hydrogen sulfide-depleted gas stream and the second absorber in the second unit under conditions to produce a second overhead gas stream, and a second bottoms stream that is the carbon dioxide-laden absorber stream;
(D4) partially condensing the second overhead gas stream to produce a second condenser recycle stream that is recycled back to the second unit, and the carbon dioxide-depleted gas stream that is withdrawn; and
(D5) withdrawing a second reboiler stream from the second unit, that is reboiled then recycled back to the second unit.

5. The process of claim 1, wherein in step (B), the gas mixture is contacted with the first absorber in a first unit having:
(Bi) a first gaseous mixture feed line for feeding the gas mixture into the first unit;
(Bii) a first liquid feed line for feeding the first absorber into the first unit;
(Biii) a first unit top portion,
(Biv) a first condenser having a first condenser inlet line in fluid communication from the first unit top portion, a first condenser recycle line in fluid communication back to the first unit, and a first gaseous product line for withdrawing the hydrogen sulfide-depleted gas stream,
(Bv) a first unit bottom portion,
(Bvi) a first reboiler in fluid communication with the first unit bottom portion, and
(Bvii) a first unit bottoms line in fluid communication with the first unit bottom portion for recovering the hydrogen sulfide-laden absorber stream.

6. The process of claim 1, wherein in step (D), the hydrogen sulfide-depleted gas stream is contacted with the second absorber in a second unit having:
(Di) a second gaseous mixture feed line for feeding the hydrogen sulfide-depleted gas stream into the second unit,
(Dii) a second liquid feed line for feeding the second absorber into the second unit;
(Diii) a second unit top portion,
(Div) a second condenser having an second condenser inlet line in fluid communication from the second unit top portion, a second condenser recycle line in fluid communication back to the first unit, and a second gaseous product line for withdrawing the carbon dioxide-depleted gas stream,
(Dv) a second unit bottom portion,
(Dvi) a second reboiler, having a second reboiler top portion and a second reboiler bottom portion, in fluid communication with the second unit bottom portion, and
(Dvii) a second unit bottom line in fluid communication with the second unit bottom portion or the second reboiler bottom portion for recovering the carbon dioxide-laden absorber stream.

7. The process according to claim 5, wherein the first operating temperature ranges from about −10° F. to about −5° F. within the first unit top portion and from about 250° F. to about 350° F. within the first unit bottom portion, and the first operating pressure ranges from about 400 psia at within the first unit top portion to about 500 psia within the first unit bottom portion.

8. The process according to claim 6, wherein the second operating temperature ranges from about −45° F. to about −30° F. within the second unit top portion and from about −40° F. to about −35° F. within the second unit bottom portion, and the first operating pressure ranges from about 420 psia at within the second unit top portion to about 455 psia within the second unit bottom portion.

9. The process according to claim 5, wherein the first reboiler unit has an operating temperature ranging from about 300° F. to about 375° F.

10. The process according to claim 6, wherein the second reboiler unit has an operating temperature ranging from about 200° F. to about 250° F.

11. A process for converting a carbonaceous composition into a plurality of gaseous products, the process comprising the steps of:
(a) supplying a carbonaceous composition to a gasification reactor;
(b) reacting the carbonaceous composition in the gasifying reactor in the presence of steam and a gasification catalyst under suitable temperature and pressure to form a plurality of gaseous products comprising methane, hydrogen, carbon monoxide, carbon dioxide and hydrogen sulfide, the gasification catalyst comprising an alkali metal;
(c) removing a substantial portion of the hydrogen sulfide and carbon dioxide from the plurality of gaseous products according to the process of claim 1 to produce a hydrogen sulfide and carbon dioxide-depleted product gas stream; and
(d) at least partially separating the hydrogen sulfide and carbon dioxide-depleted product gas stream to produce a stream comprising a predominant amount of one of the remaining gaseous products.

12. An apparatus for the purification of a gaseous mixture comprising:
(a) a first unit comprising:
(a1) a first unit top portion,
(a2) a first unit bottom portion,
(a3) a first gaseous mixture feed line,
(a4) a first liquid feed line,
(a5) a first condenser in fluid communication with the first unit top portion, the first condenser comprising a first condenser overhead portion, a first condenser bottom portion, and a first gaseous product line in fluid communication with the first condenser overhead portion,
(a6) a first reboiler in fluid communication with the first unit bottom portion, and
(a7) a first bottoms line in fluid communication with the first unit bottom portion;
and (b) a second unit comprising:
(b1) a second unit top portion,
(b2) a second unit bottom portion,
(b3) a second gaseous mixture feed line in fluid communication with the first gaseous product line,
(b4) a second liquid feed line,
(b5) a second condenser in fluid communication with the second unit top portion, the second condenser comprising a second condenser overhead portion, a second condenser bottom portion, and a second gaseous product line in fluid communication with the second condenser overhead portion,
(b6) a second reboiler, having a second reboiler top portion and a second reboiler bottom portion, in fluid communication with the second unit bottom portion, and
(b7) a second bottoms line in fluid communication with the second unit bottom portion or the second reboiler bottom portion.

13. The apparatus of claim 12, further comprising a catalytic gasification reactor in fluid communication with the first gaseous mixture feed line.

14. The apparatus of claim 12, further comprising a first liquid-gas separation unit in fluid communication with the first bottoms line, the first liquid-gas separation unit comprising:
a first liquid-gas separation unit top portion,
a first liquid-gas separation unit bottom portion,
a first liquid recycle line in fluid communication with the first liquid-gas separation unit bottom portion, and
a third condenser in fluid communication with the first liquid-gas separation unit top portion, the third condenser comprising:
a third condenser overhead portion,
a third condenser bottom portion, and
a first gas exhaust line in fluid communication with the third condenser overhead portion.

15. The apparatus of claim 14, further comprising a sulfur recovery unit in fluid communication with the first gas exhaust line.

16. The apparatus of any one of claims 12, further comprising a second liquid-gas separation unit in fluid communication with the second bottoms line, the second liquid-gas separation unit comprising:
a second liquid-gas separation unit top portion,
a second liquid-gas separation unit bottom portion,
a second liquid recycle line in fluid communication with the second liquid-gas separation unit bottom portion, and
a fourth condenser in fluid communication with the second liquid-gas separation unit top portion, the fourth condenser comprising:
a fourth condenser overhead portion,
a fourth condenser bottom portion, and
a second gas exhaust line in fluid communication with the fourth condenser overhead portion.
